(19) United States
(12) Patent Application Publication
(10) Pub. No.: US 2020/0398613 A1
(43) Pub. Date: Dec. 24, 2020

(54) FIBER CORD FOR REINFORCING RUBBER

(71) Applicant: Toray Industries, Inc., Tokyo (JP)

(72) Inventors: Yoshinori Hayakawa, Okazaki (JP); Ryohei Iwama, Okazaki (JP); Yoshito Sasaki, Okazaki (JP)

(73) Assignee: Toray Industries, Inc., Tokyo (JP)

(21) Appl. No.: 16/643,958

(22) PCT Filed: Aug. 8, 2018
(86) PCT No.: PCT/JP2018/029751

§ 371 Date: Mar. 3, 2020

(30) Foreign Application Priority Data
Sep. 11, 2017 (JP) 2017-173912
Sep. 11, 2017 (JP) 2017-173913
Sep. 11, 2017 (JP) 2017-173914

(51) Int. Cl. B60C 9/00; D02G 3/48

(52) U.S. Cl. CPC B60C 9/005; D02G 3/48; B60C 9/0042

(57) ABSTRACT

A fiber cord for reinforcing rubber includes an organic fiber covered with a resin for which the average integration value of hardness measured by AFM is 150 MPa or less. A fiber cord for reinforcing rubber which could not be achieved with prior art, can be achieved with improved initial adhesiveness and heat-resistant adhesiveness as well as excellent stress relaxation for the rubber-cord composite.

### TECHNICAL FIELD

This disclosure relates to fiber cords for use in tires, hoses, belts and the like.

### BACKGROUND

Fibers such as polyester and aramid have been widely used as reinforcing materials for rubber products such as tires, hoses and belts because of their high strength, elastic modulus and thermal dimensional stability. However, if such a fiber is embedded in a rubber product as a reinforcing material and used for a long period of time, there may occur problems such as a decline in the adhesion with rubber, deterioration of the cords to cause stress relaxation in the rubber-cord composite, and a rapid decrease in the caulking pressure in rubber hoses that contain the fiber, making them unable to work satisfactorily.

The following proposals have been made to solve those problems.

Japanese Unexamined Patent Publication (Kokai) No. HEI-11-286876 discloses a rubber-reinforcing polyester fiber characterized in that when the polyester fiber is treated with a treatment agent containing a polyepoxide compound at the time of spinning or stretching, and then, after processing it into a cord, treated with a treatment agent containing a resorcinol-formalin-rubber latex (RFL) and a chlorophenol based compound, the Gurley hardness of the treated cord can be controlled at 300 mg or less by performing the treatment after adding a polybutadiene based rubber latex blended in the rubber latex.

Japanese Unexamined Patent Publication (Kokai) No. 2008-202182 discloses a hose-reinforcing polyester fiber cord including a polyester fiber to which a polyepoxide compound is added beforehand, and a treatment agent containing a resorcinol-formalin-rubber latex (RFL) and chloro-modified resorcinol (P), wherein the treatment agent satisfies all of:

(A) R/F=1/0.5 to 1/3 (by mole),
(B) RF/L=1/3 to 1/15 (by weight),
(C) P/RFL=1/1 to 1/5 (by weight), and
(D) RF aging time: 4 to 8 hours
(wherein R represents the amount of resorcinol; F represents the amount of formalin, L represents the amount of rubber latex; P represents the amount of chloro-modified resorcinol, RF represents the amount of resorcinol and formalin, and RFL represents the amount of resorcinol-formalin-rubber latex.)

Japanese Unexamined Patent Publication (Kokai) No. SHO-62-278395 discloses a method of reducing the stress relaxation of a rubber hose by employing a multiple copolymer rubber composed mainly of an acrylonitrile-butadiene rubber blend and an acrylic rubber based blend in an inner tube rubber layer.

However, in Japanese Unexamined Patent Publication (Kokai) No. HEI-11-286876 and Japanese Unexamined Patent Publication (Kokai) No. 2008-202182, although the initial adhesiveness is sufficiently high, the heat resistant adhesion strength is not sufficiently high. According to Japanese Unexamined Patent Publication (Kokai) No. SHO-62-278395, although an improvement in stress relaxation is achieved by modification of the rubber, no improvement in stress relaxation is achieved by reinforcing fibers, and both the initial adhesive strength and the heat resistant adhesion strength are not sufficiently high.

Thus, it could be helpful to provide a fiber cord for rubber reinforcement that exhibits improved heat resistant adhesion strength between fibers and rubber, which cannot be achieved by conventional techniques, and that hardly suffers stress relaxation in the rubber-cord composite.

### SUMMARY

We thus provide:

A rubber-reinforcing fiber cord characterized in that the organic fiber used is coated with a resin having an integral mean hardness value of 150 MPa or less as measured by AFM. In the rubber-reinforcing fiber cord, meeting the following conditions (1) to (8) is more preferable, and meeting these conditions promises further improved effects.

(1) The Gurley cord hardness is 12 mN or less.
(2) The separation between the rubber and single yarns after the vulcanization step is 10% or less of the length of the rubber-single yarn interface.
(3) The stress relaxation rate measured in the rubber-cord composite compression test is 50% or less.
(4) The stress relaxation inclination measured in the rubber-cord composite compression test is 27 or less.
(5) The maximum stress measured in the rubber-cord composite compression test is 500 N or more.
(6) The ratio (A/B) of the major axis A to the minor axis B of the cross section of the rubber-reinforcing fiber cord is 1.3 or more.
(7) The air diffusivity of the cord embedded in the rubber is 100 (mm·1000)/(min·%·dtex) or less.
(8) The organic fiber includes at least one selected from polyethylene terephthalate, nylon 66, and aramid.

We provide a rubber-reinforcing fiber cord that achieves improved heat resistant adhesion when used in rubber products, which is not achievable with conventional rubber-reinforcing fiber cords, and improved stress relaxation in the rubber-cord composite.

### BRIEF DESCRIPTION OF THE DRAWINGS

FIG. 1 is a perspective view of a Gurley cord hardness measuring instrument.

FIG. 2 is a schematic diagram showing a relationship among the cord cross section, major axis A, and minor axis B.

FIG. 3 is a schematic diagram showing the proportion of the separation between the rubber and a single yarn after the vulcanization step.

FIG. 4 is a schematic diagram showing a positional relationship between the cord and the rubber plate in a sample for rubber-cord composite compression test.

FIG. 5 is a schematic diagram of a measuring piece and a measuring device used for measuring the air diffusivity.

### EXPLANATION OF NUMERALS

1. Chuck
2. Test piece
3. Rotating rod
4. Dial
5. Needle
W1: load setting hole (25.4 mm (1 inch) from shaft)
W2: load setting hole (50.8 mm (2 inches) from shaft)
W3: load setting hole (101.6 mm (4 inches) from shaft)
6. Cord
7. Rubber plate (thickness: same as the cord gauge)
8. Rubber plate (thickness: twice the cord gauge)

### DETAILED DESCRIPTION

Our fiber cords are described in more detail below.

The rubber-reinforcing fiber cord (hereinafter occasionally referred to as the cord) is a cord made of an organic fiber. The rubber-reinforcing fiber cord is used suitably in various rubber members for various applications such as tires, belts, and hoses and the like for automobiles, and improves their durability. The term “cord” refers to a twisted organic fiber, an organic fiber twisted and then heat-treated, or an organic fiber twisted, coated with an adhesive, and then heat-treated, and a simply twisted organic fiber may be particularly referred to as a raw cord or a twisted cord.

An organic fiber used for such a rubber-reinforcing fiber cord is preferably in the form of a multifilament. There are no particular restrictions on the material used to form these organic fibers, but they preferably contain at least one selected from the group consisting of polyethylene terephthalate, polyethylene naphthalate, nylon 6, nylon 66, nylon 46, polyvinyl alcohol, rayon, and aramid from the viewpoint of versatility, durability, and industrial productivity. In particular, it is more preferable for them to contain at least one selected from the group consisting of polyethylene terephthalate, nylon 66, and aramid from the viewpoint of versatility, durability, and industrial productivity.

The organic fiber may already contain a polyepoxide compound. A typical polyepoxide compound that can be used is a compound that contains at least two or more epoxy groups per molecule in an amount of 0.1 g equivalent or more per 100 g of the compound. Specific examples include reaction products of polyhydric alcohols such as pentaerythritol, ethylene glycol, polyethylene glycol, propylene glycol, glycerol, and sorbitol with halogen-containing epoxides such as epichlorohydrin; polyepoxide compounds obtained by oxidizing unsaturated compounds with hydrogen peroxide or the like such as aromatic polyepoxides including 3,4-epoxycyclohexylmethyl-3,4-epoxycyclohexene carboxylate, bis(3,4-epoxy-6-methyl-cyclohexylmethyl) adipate, and phenol novolac type, hydroquinone type, biphenyl type, bisphenol S type, brominated novolac type, xylene modified novolac type, phenolglyoxal type, trisoxyphenylmethane type, tris phenol PA type, and bisphenol type polyepoxides. Particularly preferable are sorbitol glycidyl ether type and cresol novolac type polyepoxides.

These compounds are usually used in the form of an emulsified liquid or a solution and are applied to organic fibers. To prepare a solution, a compound may be used as it is or dissolved in water. To prepare an emulsified liquid, a compound is dissolved in a small amount of a solvent as required and emulsified using a known emulsifier such as sodium alkylbenzene sulfonate, sodium dioctylsulfosuccinate, and nonylphenol ethylene oxide adducts.

Such a polyepoxide compound may be applied together with a spinning oil agent in an organic fiber yarn formation step. The amount of the polyepoxide compound to be added at this time is preferably 0.05% to 5% by weight relative to the weight of the organic fiber. If the amount of the adhered polyepoxide compound is controlled in the above range, sufficiently large effects of the polyepoxide compound can be realized and sufficiently strong adhesion between the organic fiber and the rubber can be achieved, allowing the cord to maintain a required flexibility and ensuring high processability in the subsequent steps.

The organic fiber is not subject to restrictions associated with fineness and the number of filaments, but a total fineness of 200 to 5,000 dtex and a filament number of 30 to 1,000 are usually preferable, and a total fineness of 250 to 3,000 dtex and a filament number of 50 to 500 filaments are particularly preferable. If it is less than 200 dtex, the strength of the cord may be insufficient, whereas if it is more than 5,000 dtex, the cord may become thick and the handleability may deteriorate. If the number is less than 30 filaments, the cord may be hardened and the handleability may deteriorate. If it is more than 500 filaments, the amount of fluff may increase and the quality may deteriorate.

The rubber-reinforcing fiber cord is usually prepared by twisting such organic fiber as described above to form a raw cord (twisted cord), and then treating the raw cord with an adhesive.

It is preferable that the organic fiber or the raw cord provided with an adhesive is dried (dry treatment) at 70° C. to 150° C. for 0.5 to 5 minutes, heat-treated (hot treatment) at 180° C. to 220° C. for 0.5 to 5 minutes, and then heat-treated (hereinafter referred to as normalization treatment) at 180° C. to 220° C. for 0.5 to 5 minutes to control the physical properties of the cord. In this way, a coating film of an adhesive can be formed on the fiber surface, but the drying step can be omitted in some examples. Although there are no restrictions on the upper limit of the temperature, setting the heat treatment temperature within the above range makes it possible to form a softer adhesive film and serves to realize stronger adhesion between the rubber and the resin layer at the time of vulcanization performed to combine the rubber and the cord, thereby leading to a sufficiently large adhesive strength. On the other hand, when the temperature of the hot treatment and the normalization treatment is less than 180° C., adhesion to the rubber may become insufficient and, therefore, it is more preferable to set the temperature to 180° C. or more. The cord tension during the dry treatment is preferably 0.1 to 2.0 cN/dTex. Setting the strength in this range allows the strength of the cord to be maintained at a suitable level. Furthermore, setting the cord tension at the time of the dry treatment to 1.0 to 2.0 cN/dTex is more preferable because it allows the adhesive to be localized on the cord surface, and the maximum stress in the rubber-cord complex compression test will be increased.

The organic fiber or the raw cord may be subjected to a mechanical softening treatment to lower the cord hardness after adding an adhesive and carrying out the drying and heat treatment steps (the cord at this stage is occasionally referred to as the treated cord). The mechanical softening treatment is a treatment designed so that the resin cured during the dry heat treatment is softened by bending the cord using an edge blade.

The angle to which the cord is bent by the edge blade is preferably 100° to 130°, more preferably 115° to 125°. Setting the bending angle within the above range allows the resin to be softened effectively.

The cord tension in the mechanical softening treatment step is preferably 0.5 to 5.0 cN/dTex, more preferably 3.0 to 4.0 cN/dTex. Setting the cord tension within the above range allows the cord to be softened within a range in which a favorable cord strength can be maintained.

When twisting the organic fiber, the twist coefficient K is preferably 200≤K≤2000, more preferably 200≤K≤1,500. Setting the twist coefficient within this range allows the cord to have a high fatigue resistance and a high strength.

The twist coefficient K is expressed by the following formula:

K=T×D^{1/2}

K: twist coefficient, T: number of twists per unit length (twists/10 cm), and D: total fineness in dTex.

For the preparation of an adhesive, an RFL treatment agent prepared by adding a rubber latex (L) to a resorcin-formalin initial condensate (RF), which is used commonly, may be used to realize a practicably high rubber adhesiveness.

The RFL adhesive includes a resorcinol-formalin-rubber latex (RFL). The resorcinol-formalin-rubber latex is a mixture containing a resorcinol-formaldehyde initial condensate and a rubber latex. The resorcinol-formalin-rubber latex (RFL) is preferably prepared particularly by using a resorcinol-formaldehyde initial condensate obtained through initial condensation under the existence of an alkaline catalyst. For example, resorcinol and formaldehyde are added and mixed in an alkaline aqueous solution containing an alkaline compound such as sodium hydroxide and left at room temperature for several hours to effect initial condensation of the resorcinol and formaldehyde, followed by adding a rubber latex to form a mixed emulsion.

The resorcinol-formaldehyde initial condensate used should have a resorcinol to formaldehyde ratio by mole of 1.0:0.30 to 1.0:5.0, preferably 1.0:0.75 to 1.0:2.0. Good adhesion can be obtained by setting the mole ratio of formaldehyde in the above range.

Examples of the rubber latex used for the preparation of a resorcinol-formalin-rubber latex includes, for example, natural rubber latex, butadiene rubber latex, styrene-butadiene rubber latex, vinylpyridine-styrene-butadiene rubber latex, nitrile rubber latex, hydrogenated nitrile rubber latex, chloroprene rubber latex, chlorosulfonated rubber latex, and ethylene-propylene-diene rubber latex, which may be used alone or in combination.

The latex used preferably has a glass transition temperature of −30° C. or less. The use of a latex having a glass transition temperature not higher than the aforementioned temperature permits the formation of a softer adhesive film and ensures stronger adhesion between the rubber and the resin layer at the time of vulcanization performed for combining the rubber and the cord, thereby realizing a sufficiently large adhesive strength.

For the resorcinol-formalin-rubber latex, the blending ratio between the resorcinol-formaldehyde initial condensate and the rubber latex (resorcinol-formaldehyde initial condensate/rubber latex) is preferably 1/8 or less in terms of solid content by weight. Setting the blend ratio within the above range makes it possible to form a soft adhesive film and serves to realize stronger adhesion between the rubber and the resin layer at the time of vulcanization that is performed to combine the rubber and the cord, thereby leading to a sufficiently large adhesive strength.

The rubber-reinforcing fiber cord is a cord coated with a resin having an integral mean hardness value measured by AFM (atomic force microscopy) of 150 MPa or less.

The hardness can be represented in terms of dynamic compressive complex modulus determined by observing the geometric image of a sample using an AFM and cantilever and analyzing the resulting force curve (fitting based on the JKR theory described in Johnson, K. L., Kendall K. and Roberts, A. D., Surface energy and the contact of elastic solids, Proceedings of the Royal Society of London, Series A, Vol. 324 (1971), pp. 301-313).

Coating the cord with a resin having an integral mean hardness value measured by AFM (atomic force microscopy) of 150 MPa or less, more preferably 100 MPa or less enhances adhesion between the rubber and the resin layer during vulcanization that is performed to combine the rubber and the cord, thereby leading to a sufficiently strong adhesion. If it is more than 150 MPa, the resin will be so hard that adhesion to the rubber at the time of vulcanization will be lower, resulting in an insufficient adhesive strength.

There are no specific limitations on the method of controlling the integral mean resin hardness value measured by AFM at 150 MPa or less, but it can be achieved by, for example, using only a latex (L) having a glass transition temperature of −30° C. or less, adding an adhesive having a mixing ratio between the resorcinol-formaldehyde initial condensate and rubber latex (resorcinol-formaldehyde initial condensate/rubber latex) of 1/8 or less by solid content weight, and then performing heat treatment at a temperature of 180° C. to 220° C. after the addition of the adhesive.

The Gurley cord hardness of the rubber-reinforcing fiber cord is preferably 12 mN or less, more preferably 10 mN or less. The Gurley cord hardness represents the bending stress of the cord, and the flexibility of the cord increases as the hardness decreases. Setting the hardness to 12 mN or less increases the conformity of the cord to the rubber in the composite composed of the rubber and the cord, and strong adhesion can be obtained. There are no specific limitations on the method of setting the Gurley cord hardness to 12 mN or less, but it can be achieved by performing heat treatment at a temperature of 180° C. to 220° C. after the addition of an adhesive and controlling the tension in the mechanical softening treatment step at 0.5 cN to 5.0 cN/dTex.

For the rubber-reinforcing fiber cord, separation between the rubber and single yarns after the vulcanization step is preferably 10% or less, more preferably 7% or less, of the rubber-single yarn interface length. If it is 10% or less, the adhesion with the rubber in the vulcanization step is improved, leading to a sufficiently large adhesive strength.

There are no specific limitations on the method of controlling the separation between the rubber and single yarns after the vulcanization step at 10% or less of the rubber-single yarn interface length, but it can be achieved by, for example, using only a latex (L) having a glass transition temperature of −30° C. or less, adding an adhesive having a mixing ratio between the resorcinol-formaldehyde initial condensate and rubber latex (resorcinol-formaldehyde initial condensate/rubber latex) of 1/8 or less by solid content weight, and then performing heat treatment at a temperature of 180° C. to 220° C. after the addition of the adhesive. The term “separation” refers to the portion in which a gap is present between the single yarns and the rubber.

The rubber-reinforcing fiber cord preferably has a stress relaxation rate of 50% or less, more preferably 30% or less in the rubber-cord composite compression test. The stress relaxation rate is expressed by the following equation wherein the maximum stress (Tmax) is the stress at the moment the maximum compression is applied and T is the stress after leaving the sample for 2 hours in the rubber-cord composite compression test.

Stress relaxation rate (%)=(T max−T)/T max

If the stress relaxation rate is 50% or less, fatigue of the rubber-cord composite can be suppressed and, for example, a rubber hose formed thereof will suffer little from a decrease in caulking pressure, thus serving for production of rubber products with longer life. There are no specific limitations on the method of producing a rubber-reinforcing fiber cord having a stress relaxation rate of 50% or less, but it can be achieved by, for example, using only a latex (L) having a glass transition temperature of −30° C. or less, adding an adhesive having a mixing ratio between the resorcinol-formaldehyde initial condensate and rubber latex (resorcinol-formaldehyde initial condensate/rubber latex) of 1/8 or less by solid content weight, and then performing heat treatment at a temperature of 180° C. to 220° C. after the addition of the adhesive.

The rubber-reinforcing fiber cord preferably has a stress relaxation inclination of 27 or less, more preferably 25 or less, in the rubber-cord composite compression test. The stress relaxation inclination is the inclination of the approximate straight line that is obtained when the change in stress that occurs during the 2 hour standing period after the time of maximum compression in the rubber-cord composite compression test is plotted on a logarithmic graph. If the inclination is 27 or less, it is preferable because it serves to suppress the fatigue of the rubber-cord composite. There are no specific limitations on the method of obtaining a rubber-reinforcing fiber cord that shows a stress relaxation inclination of 27 or less in the rubber-cord composite compression test, but it can be achieved by, for example, applying a pressure of 0.5 MPa or more in a nip roll apparatus while controlling the temperature of the heat treatment that is performed after adding an adhesive at 180° C. to 220° C.

The rubber-reinforcing fiber cord preferably shows a maximum stress of 500 N or more, more preferably 600 N or more, in the rubber-cord composite compression test. Controlling it at 500 N or more allows the rubber-cord composite to show a large initial stress and, for example, a rubber hose formed thereof will permit an increased caulking pressure, serving to prevent liquid leakage or the like from the rubber hose. There are no specific limitations on the method of producing a rubber-reinforcing fiber cord showing a maximum stress of 500 N or more in the rubber-cord composite compression test, but it can be achieved by, for example, using only a latex (L) having a glass transition temperature of −30° C. or less, adding an adhesive having a mixing ratio between the resorcinol-formaldehyde initial condensate and rubber latex (resorcinol-formaldehyde initial condensate/rubber latex) of 1/8 or less by solid content weight, and then performing dry treatment at a cord tension of 1.0 to 2.0 cN/dTex.

The rubber-cord composite compression test will be described later.

The air diffusivity of the rubber-reinforcing cord is preferably 130 (mm·1000)/(min·%·dtex) or less, more preferably 100 (mm·1000)/(min·%·dtex) or less. Controlling the air diffusivity as described above, leakage of the liquid from the hose can be easily prevented. % in the unit means the proportion accounted for by the adhered resin. The air diffusivity indicates the amount of air leaking from the inside of the cord in the rubber-cord composite or through a gap between the cord and the rubber, and it is preferably as small as possible.

To apply the adhesive to organic fiber or a raw cord, a preferable method is to immerse them in a dipping liquid containing the adhesive. In the dipping liquid, the solid content of the adhesive is preferably 3 to 30 wt %, more preferably 5 to 25 wt %. Controlling the solid content of the adhesive in the dipping liquid within the above range serves to obtain a sufficient adhesive strength, allow the dipping liquid to maintain appropriate storage stability, and ensure a good balance to achieve uniform adhesion of the dipping liquid over the surface of the organic fiber cord.

The amount of the adhesive adhered on the rubber-reinforcing fiber cord is preferably 0.2 to 5 wt %, more preferably 0.5 to 4 wt %, relative to the weight of the rubber-reinforcing fiber cord. Controlling the amount of the adhered adhesive within the above range obtains a favorable adhesive strength and allows the cord to maintain an appropriate flexibility, thereby improving the fatigue resistance. Furthermore, it also prevents the rolls from gumming up with solid components in the processing steps, thereby serving to realize a high operation stability.

To control the amount of the adhesive adhered to the organic fiber or the raw cord, good methods include, for example, squeezing by a pressure welding roller, scraping by a scraper or the like, blowing by compressed air, and suctioning.

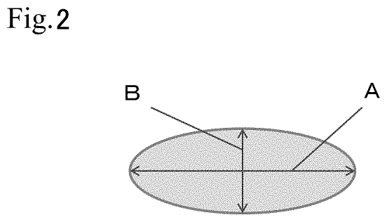

The ratio (A/B) of the major axis A to the minor axis B of the cross section of the rubber-reinforcing fiber cord is preferably 1.3 or more to form a flattened shape. The major axis A refers to the longest diameter across the cross section of the cord, and the minor axis B refers to the longest diameter orthogonal to the major axis A. FIG. 2 shows the relationship among the cord cross section, major axis A, and minor axis B. To form a cord having a cross section of a flattened shape, any appropriate method can be used such as a method in which an adhesive is applied to a raw cord (twisted cord) and then drying and heat treatment steps are carried out, followed by winding the cord while pressing it in a nip roll apparatus or the like, and a method in which a cord is formed while passing it through a flattened mold, followed by winding. When a nip roll apparatus is used to apply a pressure, the cord can be flattened by applying a pressure of 0.5 MPa or more to the cord.

The rubber-reinforcing cord can be produced by carrying out the steps described above.

It is possible to obtain a rubber-reinforcing fiber cord that shows improved heat resistant adhesiveness and practically sufficient adhesive strength to rubber during the rubber vulcanization step or during the use of products. Therefore, a rubber product that contains the rubber-reinforcing fiber cord has a practically sufficient adhesive strength between the fiber cord and the rubber, and can withstand long-term use when used as a tire, a belt, or a hose. Furthermore, the rubber-cord composite will be less liable to a significant deterioration in stress relaxation, providing rubber hoses that have improved performance, in particular, hoses that undergo a less decrease in caulking pressure, and can withstand longer-term use.

### EXAMPLES

Our fiber cords will now be illustrated in more detail with reference to examples, but it should be understood that this disclosure is not construed as being limited to these examples. The methods used for the measurement and evaluation of characteristic values of the rubber-reinforcing cord (hereinafter occasionally referred to as “the cord”) are as described below.

### (1) Amount of Adhered Treatment Agent

This was determined by the mass based method according to JIS L 1017 (2002) 8.15 b).

### (2) Initial Peel Strength and Heat Resistant Peel Strength of Adhesion

A cord sample was wrapped around an aluminum plate without gaps, and an EPDM based rubber containing the components shown in Table 1 was attached to one side of the aluminum plate. Evaluation for the initial peel strength of adhesion was carried out after press vulcanization at 150° C. for 30 minutes and evaluation for heat resistant peel strength of adhesion was carried out after press vulcanization at 170° C. for 70 minutes. At this time, the thickness of the rubber was set to 3 mm, and the press pressure was adjusted to set the surface pressure on the rubber and the fiber cord at 3 MPa. For the winding of the fiber cord on the aluminum plate, the fiber cord was wound 200 mm length in the fiber direction and 30 mm width in the direction perpendicular to the fiber direction for each level, and the tension in the winding step was 0.5 cN/dTex. After leaving it to stand to cool, the rubber-side part of the sample to which the cord was adhered was cut and taken out from the aluminum plate, and the sample was further cut to a width of 20 mm while maintaining the length of 200 mm After placing this sample in an environment at a temperature of 20° C. and a humidity of 65%, the fiber cord was peeled from the rubber at a rate of 50 mm/min using a RTM-100 Tensilon Tester manufactured by Orientec Corporation while maintaining the angle between the rubber and the fiber cord at 90° to determine the integrated peel force which was represented in N/20 mm.

TABLE 1

| Component | Parts by weight |
|---|---|
| EPDM | 100 |
| HAF-carbon black | 90 |
| process oil (product name: A/O MIX) | 40 |
| Zinc oxide | 5 |
| stearic acid | 5 |
| vulcanizing agent (sulfur) | 4 |
| vulcanization accelerator (product name: | 3 |
| Nocceler CZ) | |

### (3) The Gurley Cord Hardness

After cutting out a 1 m long portion from the treated cord, a metallic hook was attached to one end thereof while a weight of 300 g was attached to the other end thereof, and it was hung vertically in the air for 24 hours in an environment controlled at a temperature of 25° C. and a relative humidity of 40% to prepare a sample for measurement.

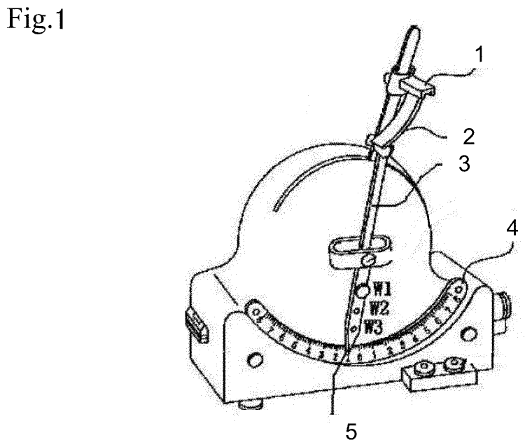

This was cut into a 38.1 mm (1.5 inch) specimen and the Gurley cord hardness was measured with Gurley's Stiffness Tester manufactured by Yasuda Seiki Co., Ltd. FIG. 1 shows a perspective view of Gurley's Stiffness Tester.

The procedure of attaching and testing the specimen is as follows: (a) the chuck 1 is fixed at a position suited to the specimen length and the specimen 2 is attached. (b) Since load setting holes are located at positions of 25.4 mm (1 inch) (W1 in FIG. 1), 50.8 mm (2 inches) (W2 in FIG. 1), and 101.6 mm (4 inches) (W3 in FIG. 1) from the shaft in the lower part (below the bearing) of the rotating rod 3, an appropriate load weight and hole position are set according to the flexibility of the specimen 2. An appropriate load and hole position should be chosen so that the needle 5 points to a value between 2 and 4 on the dial 4. (c) After setting the tester to suit the specimen 2, the drive button is pressed to move the drive shaft to the right and left, and the numerical value on the dial 4 pointed by the needle is read to the nearest 0.1. (e) For one specimen 2, measurements are taken at the right and left positrons from 10 test pieces (a total of 20 measurements), and they are averaged to give a value that represents the specimen. The calculation procedure is as follows. The average of the measurements was calculated by the following equation:

Gurley cord hardness (mN)=R×{(W1×25.4)+(W2×50.8)+(W3×101.6)}×(L−12.7)2/W×3.375×10−5

wherein
R: average of the measurements
W1: load applied to the load position (hole) at 25.4 mm (in grams)
W2: load applied to the load position (hole) at 50.8 mm (in grams)
W3: load applied to the load position (hole) at 101.6 mm (in grams)
L: specimen length (mm)
W: width of test piece (cord gauge) (mm).

### (4) AFM Analysis

After embedding the rubber-reinforcing fiber cord prepared above in epoxy resin, it was cut perpendicularly to the fiber axis using a microtome to expose a cross section of the cord, and the vicinity of the interface between the resin and the fiber was observed under a scanning probe microscope (Dimension Icon) manufactured by Bruker AXS Inc. Under an AFM set to the force volume measuring mode, observation was performed over a 4 μm×4 μm area scanned by an Olympus OMCL-AC240TS silicon cantilever (spring constant: 2 N/m), and a dynamic compressive complex modulus mapping image was obtained by analyzing the resulting force curve (fitting according to the JKR theory). From the elastic modulus mapping image obtained, resin portions not including fiber portions were separated and their elastic modulus values were estimated, followed by calculating their integral mean to represent the resin hardness (MPa).

(5) Proportion of Separation Between Rubber and Single Yarn after the Vulcanization Step

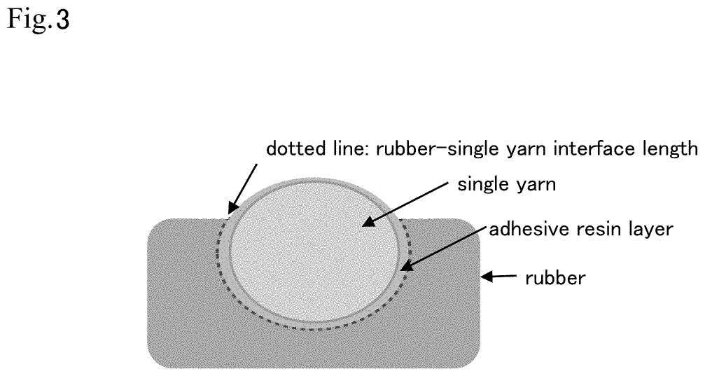

A sample was prepared by the same procedure as described in “(2) Initial peel strength”, and the central portion was cut at an angle of 90° from the length direction of the cord, followed by taking SEM photographs of the cross section. Then, 10 single yarns that are in contact with the rubber are selected appropriately to measure the rubber-single yarn separation (the rubber and single yarns are usually in contact with an adhesive layer present in between). For each of the selected single yarns, the proportion (%) of the length of the portion where the rubber and the single yarn were separated to the length of the portion where the single yarn was in contact with the rubber was calculated, and the average value (n=10) was adopted to represent the proportion of the separation between the rubber and the single yarns after the vulcanization step. The length of the portion where the single yarn was in contact with the rubber means the length measured along the outer circumference of the single yarn (see FIG. 3). Separation commonly occurs between the rubber and the adhesive layer, and the length of the separation was also measured along the outer circumference of the single yarn.

### (6) Stress Relaxation Rate Measured in the Rubber-Cord Composite Compression Test

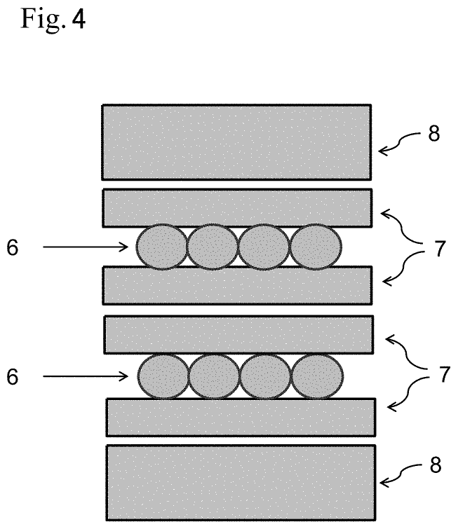

As shown in FIG. 4, the EPDM rubber composed of the components given in Table 1 was molded to the same thickness as the cord gauge of the cord to be evaluated, and pieces of the cord were arranged on the upper surface of the rubber plate while applying a tension to achieve 60,000 dtex per inch (25.4 mm), followed by attaching another EPDM rubber plate with the same thickness from above. A tension 0.5 cN/dTex was applied when arranging pieces of the cord. Two sets of this were prepared and stacked, and EPDM based rubber plates having a thickness equal to twice the cord gauge were bonded to the top and bottom of the stack, and the press vulcanization was performed at 150° C. for 30 minutes. The positional relationship between the cord and the rubber plate is shown in FIG. 4. At this time, the press pressure was adjusted to set the surface pressure on the rubber and the cord at 3 MPa. After leaving it to stand to cool, the sample was cut to provide a sample for measurement having a size of 25.4 mm laterally and 10 mm longitudinally, wherein the longitudinal direction coincides with the length direction of the cord. In an environment at a temperature of 20° C. and a humidity of 65%, the specimen for measurement was compressed by an RTM-100 Tensilon Tester manufactured by Orientec Corporation at a rate of 1 mm/min to a distance equal to seven times the cord gauge using a indenter with a contact area of 2 mm×3 mm, followed by maintaining the state for 2 hours. The stress relaxation rate was calculated by the following equation wherein the maximum stress (Tmax) is the stress at the moment the maximum compression is applied and T is the stress after leaving the sample for 2 hours.

Stress relaxation rate (%)=(T max−T)/T max

### (7) Stress Relaxation Inclination Measured in the Rubber-Cord Composite Compression Test

In the rubber-cord composite compression test (6), the change in stress from the time of maximum compression to the time of 2 hour retention was plotted on a logarithmic graph, and the inclination of the approximate straight line was calculated.

### (8) Maximum Stress in the Rubber-Cord Composite Compression Test

In the rubber-cord composite compression test (6), the stress at the time of maximum compression was defined as the maximum stress.

### (9) Ratio (A/B) Between Major Axis a and Minor Axis B of Cross Section of the Rubber-Reinforcing Fiber Cord

After cutting the cord at randomly selected 20 points, and each cross section was photographed by a microscope at a magnification of 400 times, and the major axis A and the minor axis B were measured in the photograph, followed by calculating the average (n=20) of the A/B values.

### (10) Air Diffusivity

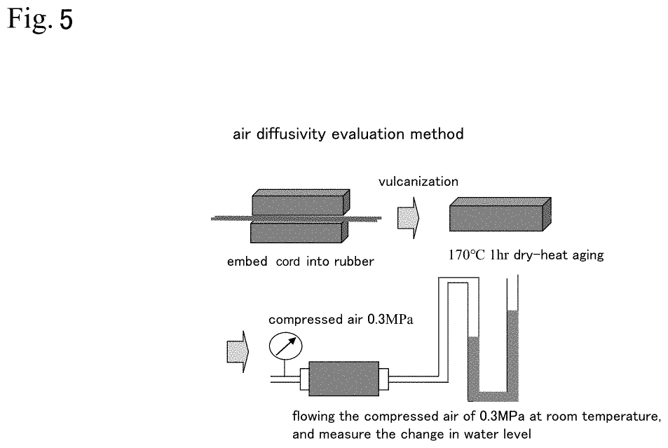

The air diffusivity was measured as follows (FIG. 5 shows an outline of the test piece for measurement and the measuring device). Two sections of the cord were arranged side by side in the length direction between two EPDM based rubber plates (1 cm wide×5 cm long×0.5 cm thick) composed of the components given in Table 1, and press vulcanization was performed at 160° C. for 30 minutes to prepare a 5 cm long test piece for measurement in which the end faces of the cord sections were exposed at both ends. The test piece for measurement was left for 1 hour in an air circulation type dry heating oven set at 170° C., taken out, and allowed to cool to room temperature. The device was able to apply a certain level of air pressure to the end face of the test piece for measurement where the end faces of the cord sections were exposed whereas a U-shaped tube with a diameter of 6 mm containing water was connected to the other end face to allow the diffusivity of air passing through the cord to be calculated from the change in the height of the water column. Under an air pressure maintained at 0.3 Mpa, the test piece was left to stand at room temperature (23° C.) for 5 minutes and then the change in water level (mm) was measured to determine the air diffusion ((mm·1000)/(min·%·dtex)) per minute, per unit amount of the adhesive, and per unit fineness.

### Example 1

A dipping liquid containing an RFL adhesive composed of a resorcinol-formalin initial condensate (RF) and a rubber latex (L) mixed at a RF/L ratio of 1/20 by solid content was prepared. The preparation method for the RFL adhesive based dipping liquid is as described below.

The initial condensate (RF) of resorcinol (R) and formalin (F) was a resorcinol-formalin initial condensate having a (R/F) mole ratio of 1/2 and a solid content of 20 wt % and aged for 6 hours in the presence of a sodium hydroxide catalyst. Thereafter, the rubber latex described below was added to bring the solid content to 20%, and after aging for 24 hours, ion exchanged water was added to prepare a RFL adhesive based dipping liquid having a solid content of 10 wt %.

### Rubber Latex: 2518FS (Manufactured by Zeon Corporation, Tg=−44° C.)

A polyethylene terephthalate multifilament yarn of 1,670 dTex (Tetron (registered trademark) 1670-288-707C, manufactured by Toray Industries, Inc.), to which the polyepoxide compound described below had been added to 0.3 wt % beforehand, was twisted at a twist of 160 t/m to obtain an untreated cord (raw cord).

### Polyepoxide Compound: EX-421 (Manufactured by Nagase ChemteX Co., Ltd.)

The untreated cord was immersed in the RFL adhesive based dipping liquid using a Computreater treating machine (manufactured by CA Litzler Co. Inc.), and then dried (dry treatment) at 120° C. for 2 minutes, followed by heat treatment (hot treatment) at 190° C. for 0.5 minute and additional heat treatment (normalization treatment) at 190° C. for 0.5 minute. The treated cord was bent at 120° using an edge blade and mechanically softened under a tension of 3.5 cN/dtex to obtain a rubber-reinforcing fiber cord.

The adhesion amount of the adhesive, proportion of separation between the rubber and single yarns after the vulcanization step, hardness (integral mean of hardness) measured by AFM, Gurley cord hardness, air diffusivity, initial peel strength, and heat resistant peel strength of the resulting treated cord were measured. Results are shown in Table 2. Examples 2 to 6 and Comparative Examples 1 to 6

Except that the RF/L ratios, heat treatment temperatures, and adhesion amounts of adhesives were changed from those used in Example 1 as shown in Tables 2 and 3, treatment was carried out under the same condition as in Example 1 and evaluation was performed in the same manner Evaluation results are also given in Tables 2 and 3.

TABLE 2

| | | | Example | Example | Example | Example | Example | Example |
|---|---|---|---|---|---|---|---|---|
| | | | 1 | 2 | 3 | 4 | 5 | 6 |
| Components of | RF/L ratio | weight ratio | 1/20 | 1/15 | 1/10 | 1/20 | 1/15 | 1/10 |
| adhesive | | | | | | | | |
| Heat treatment | drying temperature | ° C. | 120 | 120 | 120 | 120 | 120 | 120 |
| temperature | heat treatment temperature | ° C. | 190 | 190 | 190 | 210 | 210 | 210 |
| Amount of adhesive | adhesion amount | wt % | 1.5 | 1.6 | 1.4 | 1.5 | 1.6 | 1.5 |
| Single yarn-rubber | peeling proportion | % | 2 | 3 | 4 | 4 | 3 | 7 |
| separation | | | | | | | | |
| Hardness | AFM resin hardness | MPa | 92 | 110 | 125 | 120 | 131 | 142 |
| | Gurley cord hardness | mN | 7.5 | 8.0 | 9.1 | 8.9 | 11.2 | 12.9 |
| — | air diffusivity | mm · 1000/ | 37 | 55 | 48 | 70 | 75 | 84 |
| | | min · % · dtex | | | | | | |
| Adhesiveness | initial peel strength | N/20 mm | 82 | 76 | 70 | 73 | 67 | 60 |
| | heat resistant peel strength | N/20 mm | 76 | 69 | 60 | 67 | 59 | 51 |

TABLE 3

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Components | RF/L ratio | weight ratio | ½ | ½ | ½ | 1/20 | 1/15 | 1/10 |
| of adhesive | | | | | | | | |
| Heat treatment | drying temperature | ° C. | 120 | 120 | 120 | 120 | 120 | 120 |
| temperature | heat treatment | ° C. | 240 | 210 | 190 | 240 | 240 | 240 |
| | temperature | | | | | | | |
| Amount of adhesive | adhesion amount | wt % | 1.5 | 1.5 | 1.6 | 1.5 | 1.4 | 1.5 |
| Single yarn-rubber | peeling proportion | % | 20 | 17 | 15 | 18 | 16 | 14 |
| separation | | | | | | | | |
| Hardness | AFM resin hardness | MPa | 235 | 205 | 180 | 201 | 192 | 170 |
| | Gurley cord | mN | 18.1 | 16.2 | 15.1 | 16.0 | 15.2 | 14.5 |
| | hardness | | | | | | | |
| — | air diffusivity | mm · 1000/ | 280 | 262 | 237 | 135 | 171 | 185 |
| | | min · % · dtex | | | | | | |
| Adhesiveness | initial peeling | N/20 mm | 45 | 50 | 54 | 51 | 55 | 59 |
| | adhesive strength | | | | | | | |
| | heat resistant | N/20 mm | 30 | 32 | 34 | 38 | 40 | 41 |
| | peeling adhesive | | | | | | | |
| | strength | | | | | | | |

### Example 7

Except that compared to Example 1, a sample was prepared by winding while applying a nip pressure of 1.1 MPa to cause flattening after carrying out the mechanical softening step, treatment was performed under the same conditions as in Example 1 to obtain a rubber-reinforcing fiber cord.

The adhesion amount, the flatness ratio, hardness measured by AFM (integral mean of hardness), Gurley cord hardness, initial peel strength, heat resistant peel strength, stress relaxation rate in the rubber-cord composite compression test, stress relaxation inclination, and maximum stress of the resulting cord were evaluated. Results are shown in Table 4.

### Examples 8 to 13 and Comparative Examples 7 to 9

Except that compared to Example 7, the RF/L ratio and the heat treatment temperature were changed as shown in Tables 4 and 5, that the softening conditions and the nip pressure were changed, and that the Gurley hardness and the flattening ratio were changed, treatment was carried out under the same conditions as in Example 7 and evaluation was performed in the same manner. Evaluation results are also given in Tables 4 and 5.

TABLE 4

| | | | Example | Example | Example | Example | Example | Example | Example |
|---|---|---|---|---|---|---|---|---|---|
| | | | 7 | 8 | 9 | 10 | 11 | 12 | 13 |
| Components of | RF/L ratio | ratio | 1/20 | 1/20 | 1/20 | 1/20 | 1/20 | 1/20 | 1/10 |
| adhesive | | | | | | | | | |
| Heat treatment | dried temperature | ° C. | 120 | 120 | 120 | 120 | 120 | 120 | 120 |
| temperature | heat treatment temperature | ° C. | 190 | 190 | 190 | 190 | 210 | 210 | 190 |
| Amount of adhesive | adhesion amount | wt % | 1.5 | 1.5 | 1.6 | 1.4 | 1.5 | 1.5 | 1.4 |
| flattened ratio | major axis A/minor axis B | — | 1.5 | 1.5 | 1.0 | 1.2 | 1.2 | 1.0 | 1.5 |
| Hardness | AFM resin hardness | MPa | 92 | 96 | 92 | 93 | 130 | 128 | 145 |
| | Gurley cord hardness | mN | 7.5 | 13.1 | 8.0 | 11.2 | 13.4 | 12.9 | 14.8 |
| Adhesiveness | initial peeling adhesive strength | N/20 mm | 82 | 73 | 79 | 69 | 73 | 60 | 72 |
| | heat resistant peeling adhesive | N/20 mm | 76 | 64 | 74 | 61 | 67 | 51 | 58 |
| | strength | | | | | | | | |
| Rubber-cord | stress relaxation rate | % | 18 | 24 | 31 | 28 | 36 | 43 | 35 |
| composite test | stress relaxation inclination | — | 22.6 | 24.3 | 25.6 | 25.6 | 28.4 | 29.4 | 27.7 |
| | maximum stress | N | 670 | 690 | 590 | 430 | 530 | 420 | 560 |

TABLE 5

| | | | Comparative | Comparative | Comparative |
|---|---|---|---|---|---|
| | | | Example 7 | Example 8 | Example 9 |
| Components of | RF/L ratio | ratio | ½ | ½ | 1/20 |
| adhesive | | | | | |
| Heat treatment | dried temperature | ° C. | 120 | 120 | 120 |
| temperature | heat treatment | ° C. | 240 | 210 | 240 |
| | temperature | | | | |
| Amount of adhesive | adhesion amount | wt % | 1.4 | 1.3 | 1.5 |
| Flattening ratio | major axis A/minor | — | 1.1 | 1.0 | 1.0 |
| | axis B | | | | |
| Hardness | AFM resin hardness | MPa | 235 | 205 | 210 |
| | Gurley cord hardness | mN | 18.1 | 16.2 | 14.5 |
| Adhesiveness | initial peeling | N/20 mm | 45 | 50 | 59 |
| | adhesive strength | | | | |
| | heat resistant peeling | N/20 mm | 30 | 32 | 41 |
| | adhesive strength | | | | |
| Rubber-cord | stress relaxation rate | % | 61 | 58 | 52 |
| composite test | stress relaxation | — | 31.3 | 30.6 | 29.6 |
| | inclination | | | | |
| | maximum stress | N | 580 | 540 | 520 |

As seen from the results given in Tables 2, 3, 4, and 5, our rubber-reinforcing fiber cords prepared in Examples are higher in initial adhesive strength and heat resistant peel strength (heat resistant adhesive strength) and give better results for the stress relaxation rate, maximum stress, and stress relaxation inclination in the rubber-cord composite compression test compared to conventional rubber-reinforcing fiber cords (Comparative Examples).

1.-10. (canceled)

11. A rubber-reinforcing fiber cord comprising an organic fiber coated with a resin having an integral mean hardness of 150 MPa or less as measured by AFM.

12. The rubber-reinforcing fiber cord as set forth in claim 11, having a Gurley cord hardness of 12 mN or less.

13. The rubber-reinforcing fiber cord as set forth in claim 11, wherein separation between rubber in the cord and single yarns forming the cord after vulcanization is 10% or less of the rubber-single yarn interface length.

14. The rubber-reinforcing fiber cord as set forth in claim 11, having a stress relaxation rate measured in a rubber-cord composite compression test of 50% or less.

15. The rubber-reinforcing fiber cord as set forth in claim 11, having a stress relaxation inclination measured in a rubber-cord composite compression test of 27 or less.

16. The rubber-reinforcing fiber cord as set forth in claim 11, wherein maximum stress measured in a rubber-cord composite compression test is 500 N or more.

17. The rubber-reinforcing fiber cord as set forth in claim 11, wherein a ratio (A/B) of a major axis A to a minor axis B of a cross section of the rubber-reinforcing fiber is 1.3 or more.

18. The rubber-reinforcing fiber cord as set forth in claim 11, wherein air diffusivity of the cord embedded in the rubber in the cord is 100 (mm·1000)/(min·%·dtex) or less.

19. The rubber-reinforcing fiber cord as set forth in claim 11, wherein the organic fiber comprises at least one selected from the group consisting of polyethylene terephthalate, nylon 66 and aramid.

20. A rubber product comprising a rubber-reinforcing fiber cord as set forth in claim 11.
